(19) United States
(12) Patent Application Publication
(10) Pub. No.: US 2008/0270520 A1
(43) Pub. Date: Oct. 30, 2008

(54) Provision of Personal Data in a Data Communications Network

(75) Inventors: Luke Michael Reid, Dunedin (NZ); Matteo Berlucchi, London (GB)

Correspondence Address: BAINWOOD HUANG & ASSOCIATES LLC, 2 CONNECTOR ROAD, WESTBOROUGH, MA, 01581, US

(73) Assignee: SKINKERS LIMITED, LONDON (GB)

(21) Appl. No.: 11/667,870

(22) PCT Filed: Nov. 8, 2005
(86) PCT No.: PCT/GB2005/004311

§ 371 Date: Feb. 12, 2008

(30) Foreign Application Priority Data
Nov. 16, 2004 (GB) 0425246.6

(51) Int. Cl. G06F 15/173; H04L 9/32

(52) U.S. Cl. 709/203; 726/7

(57) ABSTRACT

A method for the provision of personal data in a data communications network, using requests directed from a client terminal to a server, said method including: on said client terminal, determining when a check for the availability of personal data should be performed; when said check is to be performed, transmitting a first request from said client terminal to said server, said server being capable of indicating to said client terminal whether personal data is available or not; on said client terminal, determining whether to send a second request from said client terminal to said server on the basis of whether personal data is available or not; transmitting a second request when personal data is available; and in response to said second request, receiving said personal data.

### FIELD OF THE INVENTION

The present invention relates to a method for the provision of personal data in a data communications network, using requests directed from a client terminal to a server. The invention further relates to a method for indicating the availability of personal data to be provided in a data communications network, in response to requests directed from a client terminal to a server. The invention also relates to apparatus, and computer software, arranged to conduct the method of the invention.

### BACKGROUND OF THE INVENTION

Many companies have database driven websites that identify users using information of a private nature, typically an email address and a password pair. Users can log in from time to time, browse content and access services which may be customised based on their preferences. In some situations, the company will want to alert users who are not currently logged into the system of new personal data in the shortest possible time. Typically in this case, a user will be sent an email prompting him to visit the website to access the new personal data in the database. In some applications, such as Internet banking, the user will then access his personal data using a secure connection.

However, in the case of financial data, new data may be considered old in a matter of minutes and a company will need to alert a user in near real time using push technology and computer software applications, such as desktop alert icons appearing in front of any other application on the user terminal's screen. Unfortunately, there are a number of problems associated with implementing push technology using software and the Internet, one of which being to maintain open transmission control protocol/Internet protocol (TCP/IP) connections with numerous client terminals simultaneously.

A solution to this problem is for the client terminal to poll the server associated with a database driven website on a regular basis, rather than keeping connections open, to determine if any new personal data is available. Each request from the client terminal contains information of a private nature, such as a username and a password, which should not be exposed to the un-secure network. In this case, the request from the client terminal is conducted over a computationally secure connection and each time a request is made the server must authenticate the client in an optimised manner, thus resulting in increased complexity and costs.

It would thus be desirable to implement a less costly but secure solution for a client to determine, by checking regularly a server, if any new personal data is available on a database associated with the server.

### SUMMARY OF THE INVENTION

In accordance with one aspect of the present invention, there is provided a method for the provision of personal data in a data communications network, using requests directed from a client terminal to a server, said method including:

on said client terminal, determining when a check for the availability of personal data should be performed;

when said check is to be performed, transmitting a first request from said client terminal to said server, said client terminal using a first client identifier to identify itself in said first request, said server being capable of indicating to said client terminal whether personal data is available by using a first response characteristic to indicate that data is currently available, and using a second response characteristic to indicate that no personal data is currently available;

on said client terminal, determining whether to send a second request from said client terminal to said server on the basis of whether said first response characteristic or said second response characteristic is received from said server;

transmitting a second request when said first response characteristic is received from said server;

in response to said second request, receiving said personal data.

The invention proposes for a client terminal to check the server on a regular basis for the availability of personal data and to authenticate itself by using a first client identifier in a first request. In turn, when notified by the server of available personal data, the client terminal sends a second request to the server to access the personal data.

A second, different client identifier could be used in the second request; in this way, use of the first client identifier does not compromise the client identifier which is used to access the personal data. The first client identifier is preferably a cryptographic hash of at least part of the second client identifier; the first client identifier can then be generated from the second, without compromising the security of the second client identifier.

The method has the advantage that sensitive information need not be sent when checking the server for the availability of personal data, thus enabling less secure protocols such as hypertext transfer protocol (HTTP) to be used in the first request, while using secure protocols such as secure hypertext transfer protocol (HTTPS) in the second request. Further, use of the present invention avoids the expense of secure connections when they are not necessary and optimizes network load.

In accordance with a second aspect of the present invention, there is provided a method for indicating the availability of personal data to be provided in a data communications network, in response to requests directed from a client terminal to a server, said method including:

on said server, having access to a store of client identifiers, said client identifiers indicating the availability of personal data for corresponding client terminals;

on said server, receiving a first request from said client terminal, said client terminal using a first client identifier to identify itself in said first request;

on said server, determining from said store of said client identifiers, whether personal data is available for said client terminal;

said server indicating to said client terminal whether personal data is available by using a first response characteristic to indicate that data is currently available, and using a second response characteristic to indicate that no personal data is currently available.

The invention allows the server to receive a first request from a client terminal, and to determine and indicate if necessary the availability of personal data to a client terminal by using a store of client identifiers on the server, the client identifiers being associated in the store with data indicating whether or not personal data is available.

Another advantage of the present invention is that the server can identify the client terminal sending a request for available personal data in a straightforward manner by having access to a data store indexed by client identifiers. For example, the server could have access of a set of client identifiers which indicate that a personal data is available; if upon checking the set, the client identifier for which the check is being performed is not in the set, it is immediately ascertained that no personal data is currently available. The set of client identifiers may be held in a form most suitable for quick access, such as a set of files having file names identical to, or containing, the client identifiers. Alternatively, the set of client identifiers may be held directly in a working memory, such as a random access memory (RAM).

Further aspects of the invention are set out in the appended claims.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a block diagram of a data communications network according to a first embodiment of the present invention.

FIG. 2 is a block diagram of a data communications network according to a second embodiment of the present invention.

FIG. 3 is a flow diagram describing an example of the personal data provision method of the present invention.

### DETAILED DESCRIPTION OF THE INVENTION

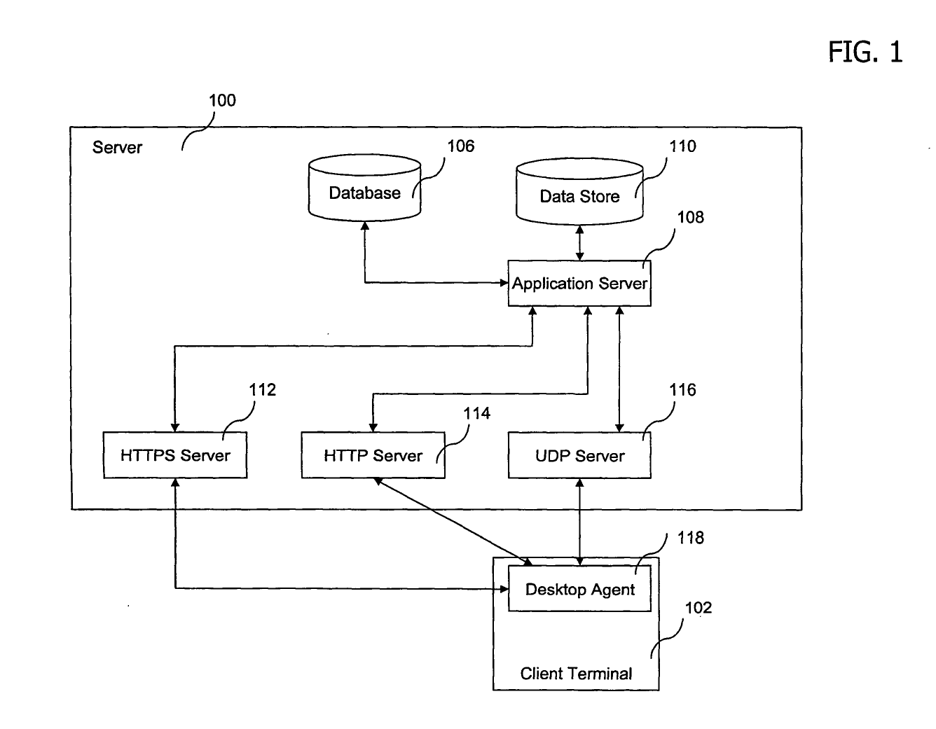

FIG. 1 is a block diagram of a data communications network according to a first embodiment of the present invention. The network is preferably the Internet and includes a server 100 and several client terminals, only one exemplary terminal 102 being represented. Where reference is made to the exemplary client terminal 102 below, it should be understood that reference is being similarly made to other of the participating client terminals of the network. In the network, the server 100 hosts a database driven website, which database 106 intermittently receives personal data for a user of the client terminal 102. The client terminal 102 checks the server 100 to determine if any new personal data is available in the database 106 by transmitting a request to the server 100 on a regular basis, rather than keeping a connection permanently open. On the basis of the response characteristic of the server to the request, the client terminal will determine whether to send a further request to access personal data using a secure connection. Details of the invention will be described below in further detail.

When new personal data is available in the database 106, the application server 108 generates data items which are stored in a data store 110. The data items could be personal alert messages or data indicating that new personal data is currently available or not.

The client terminal 102, which can for example be a personal computer, cellular telephone, personal digital assistant (PDA), etc., includes a desktop agent software 118 configured in accordance with the invention in order to interact with the server 100 and check the server on a regular basis for any new personal data in the database 106. The user identifies themselves by entering a client identifier, referred to herein as a second client identifier, such as a username, an email address, an employee identifier, an instant message identifier, a phone number, a customer number, a national insurance number, a social security number, a user number or a Windows NT domain logon identifier. This second client identifier is stored by the desktop agent 118 in secure, encrypted form on the client terminal 102.

The desktop agent 118 performs a time-based determination as to when a check is to be performed on the server 100 as to the availability of personal data. Preferably, such checks are performed on a regular basis, according to a schedule held by the desktop agent 118. The schedule preferably allows for a check to be made every ten minutes, or less, more preferably every five minutes or less, yet more preferably every minute or less.

When it is determined that a check is to be performed by the client terminal for the availability of personal data, a first client identifier is used by the client terminal to identify itself in the transmission of a first request to the server 100. Preferably, the first client identifier, which is different from the second client identifier, is generated from at least part of the second client identifier. Most preferably the first client identifier is created by applying a cryptographic hash function to at least part of the second client identifier. Security can be set at an appropriate level by selection of the cryptographic hash size. The first client identifier, once generated, may be sent in plaintext form to the server in the first request. Preferably, the first request is sent using a communication protocol having a relatively low signalling load. In particular, the communication protocol used is preferably a non-encryption based protocol, such as standard, non-encrypted HTTP or user datagram protocol (UDP). As can be seen on FIG. 1, the first request is received respectively on the HTTP server 114 or UDP server 116.

According to the invention, the same hashing function of the second client identifier is performed whenever personal data is available for the client terminal 102 on the server 100. The data store 110 can be indexed by a set of first client identifiers representing users for whom personal data is available.

Once the first request is received by the server 100, the associated application server 108 searches for the corresponding client identifier in the data store 110. The server is capable of indicating to the client terminal whether personal data is available by using a first response characteristic to indicate that data is currently available or by using a second response characteristic to indicate that no personal data is currently available. In the latter case, when there is no matching first client identifier in the data store 110, the application server 108 may simply not respond to the first request from client terminal 102 and the connection therefore may be closed. Alternatively, if a matching first identifier is found, a response to the first request is transmitted to the client terminal using the HTTP server 114, or UDP server 116, respectively.

On the basis of whether a first or a second response characteristic is received from the server, the desktop agent 118 on the client terminal 102 determines whether to send a second request to the server 100 using the second client identifier mentioned above to identify itself in order to access the available personal data of the database 106. The second client identifier is preferably sent with authentication data, such as a password, both of which are preferably sent in encrypted form. The second request has a higher signalling load than the first request, and is preferably sent using an encryption-based protocol. For example, the second request can be sent using HTTPS. As can be seen on FIG. 1, the second request is received on the HTTPS server 112. Using the second identifier to identify the personal data, the server 100 transmits the identified personal data in encrypted form to the client terminal 102 where it can be displayed by the desktop agent 118. The response to the second request is transmitted to the client terminal using the HTTPS server 112.

The storage of data on the server could be implemented by maintaining a list of all client identifiers using the operating system's file system as the data store. This could be done with the client identifier being used as the file name. To access this data, the client terminal could use any protocol used for accessing files, such as file transfer protocol (FTP), trivial file transfer protocol (TFTP) or HTTP, and request a file with a file name corresponding to the client identifier.

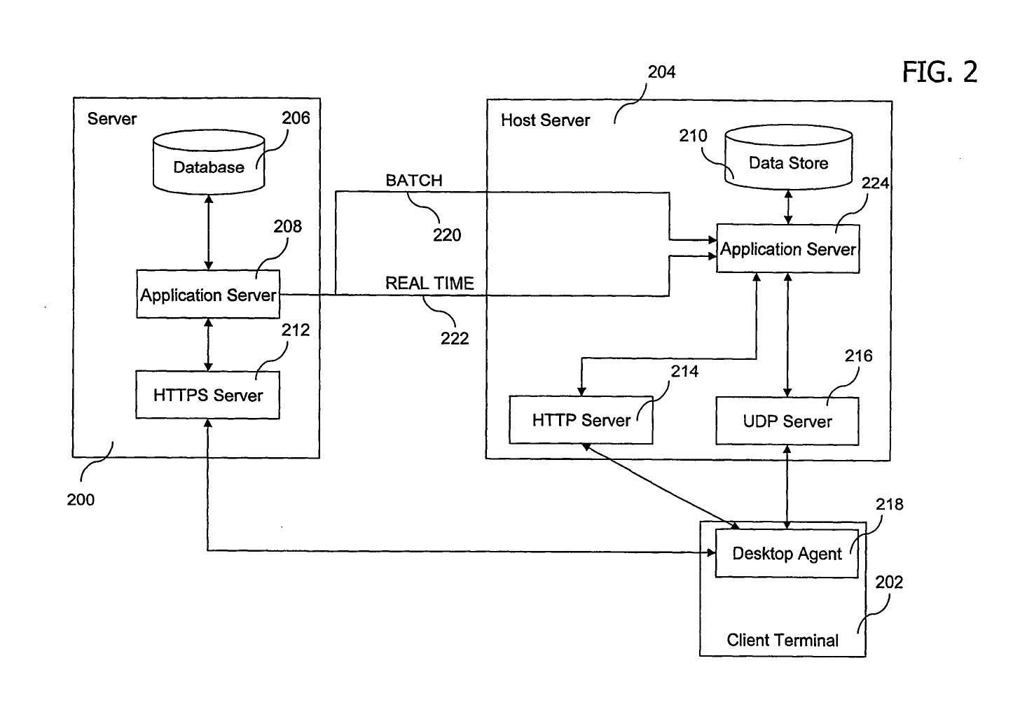

FIG. 2 is a block diagram of a data communications network according to a second embodiment of the present invention. In this embodiment, the data store 210 is hosted on a host server 204. An additional server 200 hosts a database driven website whose database 206 contains users' personal data for its users. When new information is added to the users' personal data in the database 206, the application server 208 of server 200 will generate data items that are then transmitted to the host server 204 to indicate that new personal data is currently available.

In this embodiment, the data items can be transmitted from the server 200 to the host server 204 by batches of multiple data items using FTP or a secure protocol such as secure copy protocol (SCP) along a batch upload data link 220. The data items could alternatively be transmitted in real time using protocols such as simple object access protocol (SOAP) or common object request broker architecture/Internet inter-ORB protocol (CORBA/IIOP), along real time link 222. The data store 210 is also indexed by first client identifiers which are preferably a cryptographic hash of at least second client identifiers. The hashing function could be conducted either on the server 200 or on the host server 204.

As in the first embodiment, the client terminal 202 transmits a first request to the application server 224 of host server 204 using a first client identifier via HTTP server 214 or UDP server 216. On the basis of whether a first or a second response characteristic was received from the host server 204, the invention allows the client terminal 202 to determine whether to send a second request to the server 200 using a second client identifier to identify itself in order to access the available personal data of the database 206 via HTTPS server 212. By using a separate host server, this embodiment avoids as much as possible any change in the separate server 200 when implemented. In practice, the host server can be used with a plurality of separate servers 200, each with its own user base.

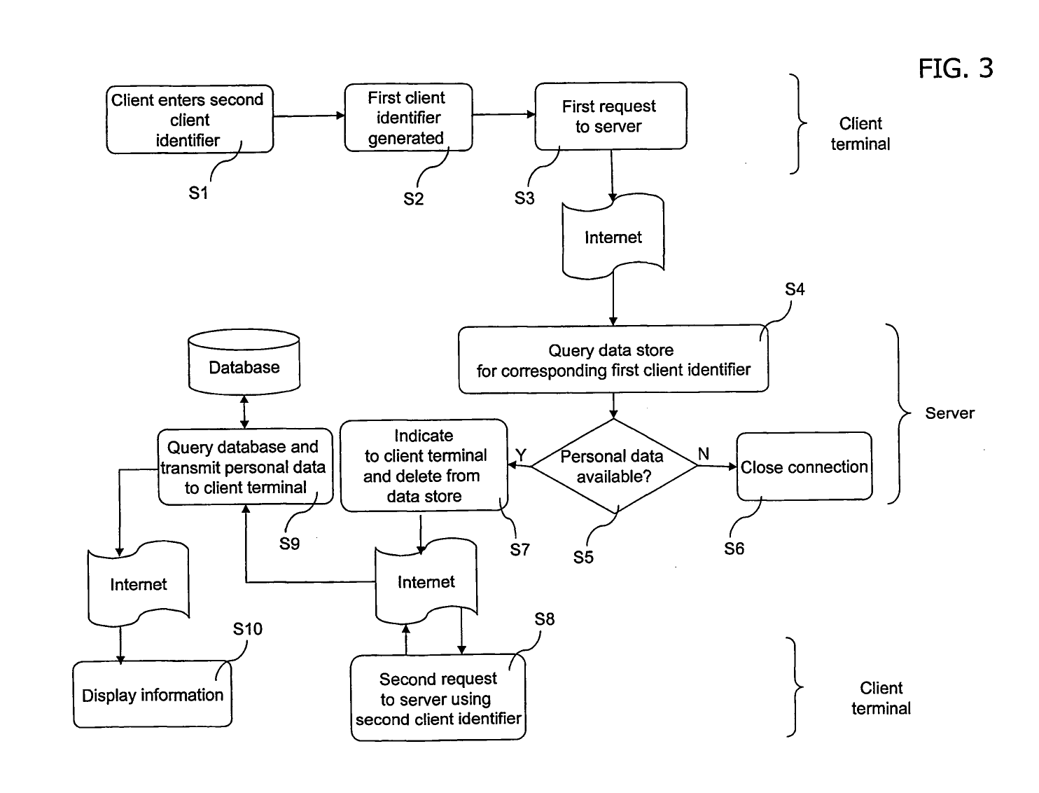

FIG. 3 is a flow diagram describing an example of the personal data provision method of the present invention. In step S1, the user enters a second client identifier, such as those mentioned above and a password on the client terminal. When it is determined by the desktop agent 118 that a check for the availability of personal data should be performed, a first request using the first client identifier is transmitted. The second client identifier is cryptographically hashed on the client terminal using a hash algorithm to generate the first client identifier, step S2, which is used to authenticate the client terminal in a first request to the server, step S3, using for example HTTP.

The server receives the first request and looks up the corresponding first client identifier in a data store containing an index of client identifiers, step S4, and determines from the data associated with the first client identifier whether personal data is available for the client terminal, step S5.

The server indicates to the client terminal that personal data is currently available by using a first response characteristic. Preferably, a response is transmitted to the client terminal, the connection is closed and the corresponding information is deleted from the data store, step S7.

The first response characteristic having been received on the client terminal, the client terminal uses the second client identifier to transmit a second request for accessing personal data to the server using HTTPS, step S8.

If there is no personal data available, the server uses a second response characteristic. Preferably there is no response transmitted to the client terminal and the connection is closed, step S6.

At step S9, the server receives the second request and uses the second client identifier to identify the personal data in the database which is then transmitted by the server and received by the client terminal in order to be displayed on-screen, step S10.

The personal data, which is intermittently made available, may be derived from many different sources, depending on the application which the present invention is being used in conjunction with. Applications to banking, financial or casino database driven websites are envisaged. In this regard, the personal data which is received may be generated in an automated system, in response to trigger events, such as a financial transaction, a winning bet, etc. Alternative applications include messaging systems, where the personal data is received from one user, and addressed to another user.

The above embodiments are to be understood as illustrative examples of the invention.

In the above embodiments, the first client identifier is related to the second client identifier by means of a hashing function. However, other algorithms may be used to generate the first client identifier from at least part of the second client identifier, and possibly other data, including public key cryptography, etc. Further, the first client identifier may be related to the second client identifier by means of data stored in a lookup table in a location accessible to the, or one of, the servers, involved in the transaction.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for the provision of personal data in a data communications network, using requests directed from a client terminal to a server, said method including:
on said client terminal, determining when a check for the availability of personal data should be performed;
when said check is to be performed, transmitting a first request from said client terminal to said server, said client terminal using a first client identifier to identify itself in said first request, said server being capable of indicating to said client terminal whether personal data is available by using a first response characteristic to indicate that data is currently available, and using a second response characteristic to indicate that no personal data is currently available;
on said client terminal, determining whether to send a second request from said client terminal to said server on the basis of whether said first response characteristic or said second response characteristic is received from said server;
transmitting a second request when said first response characteristic is received from said server; and
in response to said second request, receiving said personal data.

2. A method according to claim 1, wherein said client terminal uses a second client identifier, different to said first client identifier, to identify itself in said second request.

3. A method according to claim 2, wherein said second client identifier includes one or more of a username, an email address, an employee identifier, an instant message identifier, a phone number, a customer number, a national insurance number, a social security number, a user number, a Windows NT domain logon identifier.

4. A method according to claim 2, comprising generating said first client identifier from at least part of said second client identifier.

5. A method according to claim 4, wherein said first client identifier is created from a cryptographic hash of at least part of said second client identifier.

6. A method according to claim 1, wherein said first client identifier is sent in plaintext form in said first request.

7. A method according to claim 2, wherein said second client identifier is sent in encrypted form in said second request.

8. A method according to claim 1, wherein said first request is sent using a first communication protocol, and said second request is sent using a second, different, communication protocol, said first and second protocols being used such that said second request has a higher signalling load than said first request.

9. A method according to claim 8, wherein said first request is sent using HTTP.

10. A method according to claim 8, wherein said first request is sent using UDP.

11. A method according to claim 8, wherein said second request is sent using an encryption-based protocol.

12. A method according to claim 11, wherein said second request is sent using HTTPS.

13. A method according to claim 1, wherein one of the first and second response characteristics involves a response being received, and the other of said first and second response characteristics involves no response being received.

14. A method according to claim 13, wherein said first response characteristics involves a response being received, and said second response characteristics involves no response being received.

15. A method for indicating the availability of personal data to be provided in a data communications network, in response to requests directed from a client terminal to a server, said method including:
on said server, having access to a store of client identifiers, said client identifiers indicating the availability of personal data for corresponding client terminals;
on said server, receiving a first request from said client terminal, said client terminal using a first client identifier to identify itself in said first request;
on said server, determining from said store of said client identifiers whether personal data is available for said client terminal;
said server indicating to said client terminal whether personal data is available by using a first response characteristic to indicate that data is currently available, and using a second response characteristic to indicate that no personal data is currently available.

16. A method according to claim 15, comprising:
receiving a second request from said client terminal, said client terminal using a second client identifier to identify itself in said second request;
using said second client identifier to identify said personal data;
in response to said second request, transmitting said identified personal data.

17. A method according to claim 16, comprising generating said first client identifier from at least part of said second client identifier.

18. A method according to claim 17, wherein said first client identifier is created from a cryptographic hash of at least part of said second client identifier.

19. A method according to claim 16, wherein a response to the second request of said client terminal is transmitted to the client terminal using an encryption-based protocol.

20. A method according to claim 19, wherein a response to the second request of said client terminal is transmitted to the client terminal using HTTPS.

21. A method according to claim 15, wherein said store of client identifiers on said server is indexed by said first client identifiers.

22. A method according to claim 21, wherein said store includes a file system, said first client identifier being used as a file name.

23. A method according to claim 15, wherein one of the first and second response characteristics involves a response being sent, the other of said first and second response characteristics involves no response being sent.

24. A method according to claim 23, wherein said first response characteristics involves a response being received, and said second response characteristics involves no response being received.

25. A method according to claim 15, wherein said first request from said client terminal is received using HTTP or UDP.

26. Apparatus arranged to conduct the method of claim 1.

27. (canceled)

28. Apparatus arranged to conduct the method of claim 15.

29. (canceled)

30. A system for communication of data between a server and at least one client terminal in a data communications network, said system including:
at least one data source;
a database, said database comprising personal data derived from said data source and having an interface;
a data store, said data store comprising data items which indicate the availability of new personal data in said database and having an interface;
at least one client terminal;
first communication means for conducting a first communication link allowing said client terminal to transmit a first request to said data store interface for new personal data and for said data store interface to transmit a response indicating whether new personal data is available on the basis of said data items of said data store;
second communication means for conducting a second communication link allowing said client terminal to transmit a second request to said database interface for obtaining said new personal data in said database and for database interface to transmit said personal data to said client terminal.

31. A system for communication of data between a server and at least one client terminal in a data communications network, said system including:
at least one data source;
a first server having access to a database, said database comprising personal data derived from said data source;
a second server having access to a data store, said data store comprising data items which indicate the availability of new personal data in said database;
server-to-server communication means for said first server to transmit said data items to said second server;
at least one client terminal having software configured to interact with said second server and check said second server on a regular basis for the availability of personal data in said database;
first communication means for said client terminal to transmit a first request to said second server for the availability of new personal data and for said second server to transmit a response indicating whether new personal data is available on the basis of said data items of said data store;
second communication means for said client terminal to transmit a second request to said first server for obtaining said new personal data in said database and for said first server to transmit said personal data.

32. A computer program product comprising a computer-readable medium having computer readable instructions recorded thereon, said computer program product being adapted to provide personal data in a data communications network using requests directed from a client terminal to a server, the computer readable instructions being operative, when performed by a computerised device, to cause the computerised device to:
on said client terminal, determine when a check for the availability of personal data should be performed;
when said check is to be performed, transmit a first request from said client terminal to said server, said client terminal using a first client identifier to identify itself in said first request, said server being capable of indicating to said client terminal whether personal data is available by using a first response characteristic to indicate that data is currently available, and using a second response characteristic to indicate that no personal data is currently available;
on said client terminal, determine whether to send a second request from said client terminal to said server on the basis of whether said first response characteristic or said second response characteristic is received from said server;
transmit a second request when said first response characteristic is received from said server; and
in response to said second request, receive said personal data.

33. A computer program product comprising a computer-readable medium having computer readable instructions recorded thereon, said computer program product being adapted to indicate the availability of personal data to be provided in a data communications network in response to requests directed from a client terminal to a server, the computer readable instructions being operative, when performed by a computerised device, to cause the computerised device to:
on said server, access a store of client identifiers, said client identifiers indicating the availability of personal data for corresponding client terminals;
on said server, receive a first request from said client terminal, said client terminal using a first client identifier to identify itself in said first request;
on said server, determine from said store of said client identifiers whether personal data is available for said client terminal;
said server indicating to said client terminal whether personal data is available by using a first response characteristic to indicate that data is currently available, and using a second response characteristic to indicate that no personal data is currently available.
